(19) United States
(12) Patent Application Publication
(10) Pub. No.: US 2010/0304582 A1
(43) Pub. Date: Dec. 2, 2010

(54) INVERSE COPLANAR ELECTRICAL CONNECTOR

(75) Inventors: Lakshminarasinga Vittapalli, Singapore (SG); Poh Tech Lim, Floravale (SG)

Correspondence Address: MOLEX INCORPORATED, 2222 WELLINGTON COURT, LISLE, IL, 60532, US

(73) Assignee: Molex Incorporated, Lisle, IL (US)

(21) Appl. No.: 12/670,907

(22) PCT Filed: Jul. 24, 2008
(86) PCT No.: PCT/US2008/008987

§ 371 Date: Aug. 12, 2010

(30) Foreign Application Priority Data
Jul. 30, 2007 (SG) 200705543-7

(51) Int. Cl. H01R 12/14

(52) U.S. Cl. 439/65; 439/660

(57) ABSTRACT

A matable electrical connector, for connecting electrical modules, is described. The connector comprising a plug, the plug including a mating end, mating terminals at the mating end, a module mounting surface substantially perpendicular to the mating end, the module mounting surface including module terminals electrically connectable to the module, and at least one circuit connecting the module terminals to the mating terminals. The connector further comprising a receptacle, the receptacle including a mating end, mating terminals at the mating end, a module mounting surface substantially perpendicular to the mating end, the module mounting surface including module terminals electrically connectable to the module, and at least one circuit connecting the module terminals to the mating terminals. The plug and the receptacle are adapted to mate in a first mode wherein the module mounting surfaces of the plug and the receptacle are substantially coplanar and a second mode wherein the plane of the module mounting surfaces of the plug and the receptacle are substantially parallel but not coplanar. The modules to be connected include PCBs.

### FIELD OF THE INVENTION

The present invention relates to electrical connectors, particularly to electrical connectors for printed circuit boards, and has application to printed circuit board connectors, which may be mated in a coplanar manner.

### BACKGROUND OF THE INVENTION

The invention has application to the electrical interconnection of modules and in particular PCB modules. Known connectors normally only allow mating in one configuration. Using plug and receptacle connectors with PCBs mounted on a surface, the PCB can usually only be mounted in the same co-plane on both the plug and receptacle. This is called coplanar mating. It would be desirable to provide a connector allowing mating to occur in more than one configuration.

Referring to the connector 100 of FIG. 3 it can be seen that if there are two circuits, circuit 1, 101 and circuit 2,102 then the current travel of circuit 1,101 is longer than the current travel of circuit 2, 102. Thus the current capacity is limited by the longer path of the outermost circuit. In FIG. 3 this is circuit 1,101. For the same current the heat generated in circuit 1,101 will be higher than in circuit 2, 102. It would be desirable to provide a connector that balanced both circuits.

### SUMMARY OF THE INVENTION

An object of at least one embodiment of the invention is to provide an electrical connector having balanced circuits or at least to provide the public or industry with a useful choice.

In a first aspect the invention may be said to consist in a matable electrical connector, for connecting electrical modules, comprising:
a plug, said plug including a mating end, mating terminals at said mating end, a module mounting surface substantially perpendicular to said mating end, said module mounting surface including module terminals electrically connectable to said module, and at least one circuit connecting said module terminals to said mating terminals; and
a receptacle, said receptacle including a. mating end, mating terminals at said mating end, a module mounting surface substantially perpendicular to said mating end, said module mounting surface including module terminals electrically connectable to said module, and at least one circuit connecting said module terminals to said mating terminals;
wherein said plug and said receptacle are adapted to mate in a first mode wherein said module mounting surfaces of said plug and said receptacle are substantially coplanar and a second mode wherein the plane of said module mounting surfaces of said plug and said receptacle are substantially parallel but not coplanar.

In a further embodiment the electrical module is a PCB.

In a further embodiment said plug has at least one circuit of a first length (said first plug circuit) and at least one circuit of a second length (said second plug circuit), said first plug circuit being shorter than said second plug circuit and said receptacle has at least one circuit of a first length (said first receptacle circuit) and at least one circuit of a second length (said second receptacle circuit), said first receptacle circuit being shorter than said second receptacle circuit and wherein when and said receptacle are mated in said second mode said first plug circuit and said second receptacle circuit connect to form a first connector circuit and said second plug circuit and said first receptacle circuit connect to form a second connector circuit, said first and said second connector circuits being substantially the same length.

In a further embodiment an electrical module is attached to each of said plug and said receptacle, each electrical module being in the same plane as said module mounting surface wherein when said plug and said receptacle are mated in said second mode, said electrical modules are staggered.

In an alternative embodiment an electrical module is attached to each of said plug and said receptacle, each electrical module being in the same plane as said module mounting surface wherein when said plug and said receptacle are mated in said second mode, said electrical modules are substantially aligned.

In an alternative embodiment a electrical module is attached to each of said plug and said receptacle, each electrical module being in the same plane as said module mounting surface wherein when said plug and said receptacle are mated in said second mode, said electrical modules overlap.

The invention may further be said to consist in any alternative combination of parts or features mentioned herein or shown in the accompanying drawings. Known equivalents of these parts or features which are not expressly set out are nevertheless deemed to be included.

### BRIEF DESCRIPTION OF THE DRAWINGS

Disclosed embodiments and methods of utilizing the invention will be further described, with reference to the accompanying FIGS., by way of example only and without intending to be limiting, wherein;

FIG. 1 is a perspective view of a plug and receptacle connector, connected in a coplanar manner,

FIG. 2 is a perspective view of a plug and receptacle connector, connected in an inverse coplanar manner,

FIG. 3 is a cross section of a plug and receptacle connector, connected in a coplanar manner,

FIG. 4 is a cross section of a plug and receptacle connector, connected in an inverse coplanar manner,

FIG. 5 is a perspective view of the electrical circuits of the plug and receptacle connector of FIG. 3,

FIG. 6 is a perspective view of the electrical circuits of the plug and receptacle connector of FIG. 4,

FIG. 7 is a perspective view of a plug and receptacle connector, connected in an inverse coplanar manner, having modules that overlap, and

FIG. 8 is a cross section of a plug and receptacle connector, connected in an inverse coplanar manner, having modules that overlap.

### DETAILED DESCRIPTION OF THE DISCLOSED EMBODIMENTS

Referring to the Figures, it will be appreciated that the invention may be implemented in various forms and modes. The following description of the disclosed embodiment of the invention is given by way of example only.

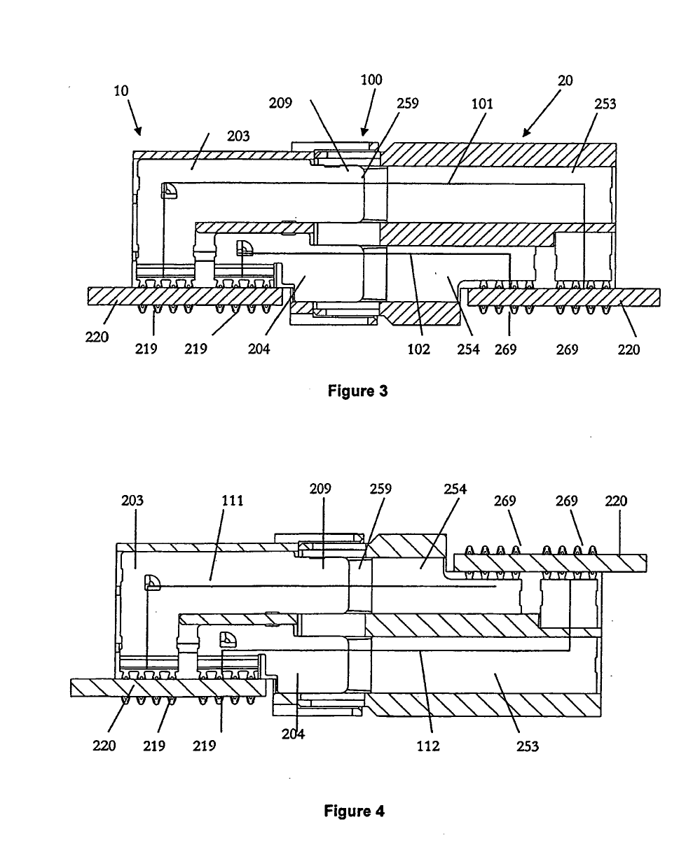

Referring to FIGS. 1 to 6, the connector of the present invention is illustrated. The plug 10 of the present invention includes an insulated homing 200 having a printed circuit board (“PCB”) mounting surface 201 for mounting a PCB 220. While described with reference to a PCB the present invention may be used to electrically connect any electrical components or electrical modules. The surface 201 may be referred to as a module mounting surface.

The plug 10 also includes a connecting or mating end 202 for mating with a receptacle 20 mating end 252. The mating end 202 is shaped and sized so that the plug 10 can be received by the receptacle mating end 252. Circuits 203, 204 for connecting the PCB 220 run from the PCB mounting surface 201 to the mating end 202. At the mating end 202 the circuits 203, 204 terminate in terminals 209 for connection to receptacle terminals. At the module mounting end the circuits terminate in terminals 219 for connecting a module.

The receptacle 20 of the present invention includes an insulated housing 250 having a printed circuit board (“PCB”) mounting surface 251 for mounting a PCB 270. A connecting or mating end 252 for mating with a plug mating end 202 is provided. The mating end is shaped and sized so that the receptacle 20 can receive the plug 10 mating end 202. Circuits 253, 254 for connecting the PCB 270 run from the PCB mounting surface 251 to the mating end 252. At the mating end 252 the circuits 253, 254 terminate in terminal 259 for connection to the plug terminals 209. At the module mounting end the circuits terminate in terminals 259 for connecting a module.

When the plug 10 and receptacle 20 are connected the circuits 203, 204 and 252, 253 connect the PCBs 220, 270. Referring to FIG. 4 it can be seen that the first circuit 111, comprising circuits 203 and 254 is the same length as the second circuit 112 comprising circuits 204 and 253. This connection allows system designers flexibility to choose the output of the power connection system as needed. Further having both circuits the same length means that the heat generated in the connector will be the same in both circuits.

In order for the circuits to be the same length the plug and the receptacle are mated so that the PCBs mounted in an inverse coplanar fashion as illustrated in FIG. 4 so that the planes of the PCBs 220, 270 are substantially parallel when the plug 10 and receptacle 20 are connected.

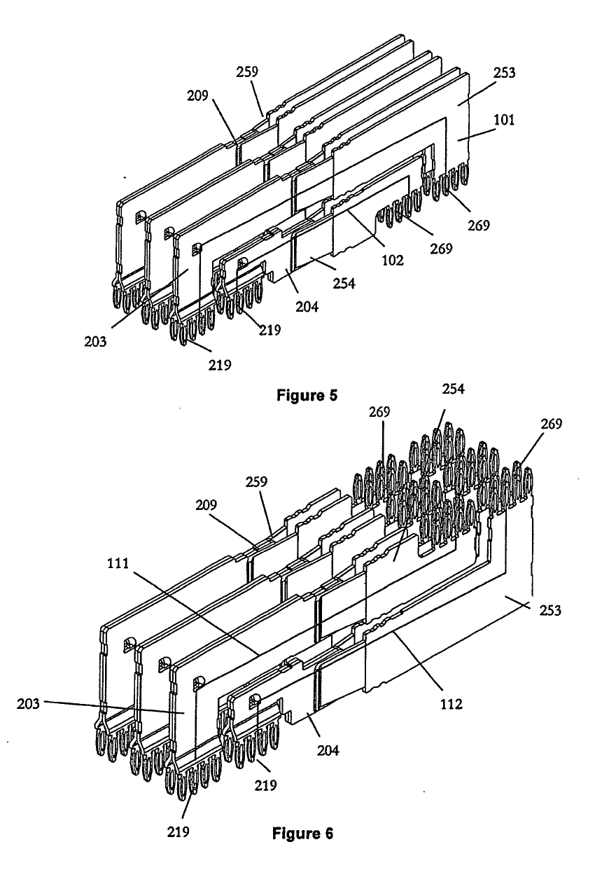

Referring specifically to FIGS. 5 and 6 illustrating the circuits 203, 204, 253 and 254 of the connector which are embedded within the insulated housings of the plug 10 and receptacle 20. The plug 10 includes a first circuit 204 having a first length and a second circuit 203 having a second length, the first circuit 204 being shorter in length between the mating terminals 209 and the module terminals 219 than the second circuit

The receptacle also has a first circuit 254 and a second circuit 253, the first circuit being shorter in length between the mating terminals 259 and the module terminals 269 than the second circuit

When the plug and the receptacle are connected/mated in a first mode as illustrated in FIGS. 1, 3 and 5 with the modules 220, 270 coplanar the first connector circuit 101 is longer than the second connector circuit 102.

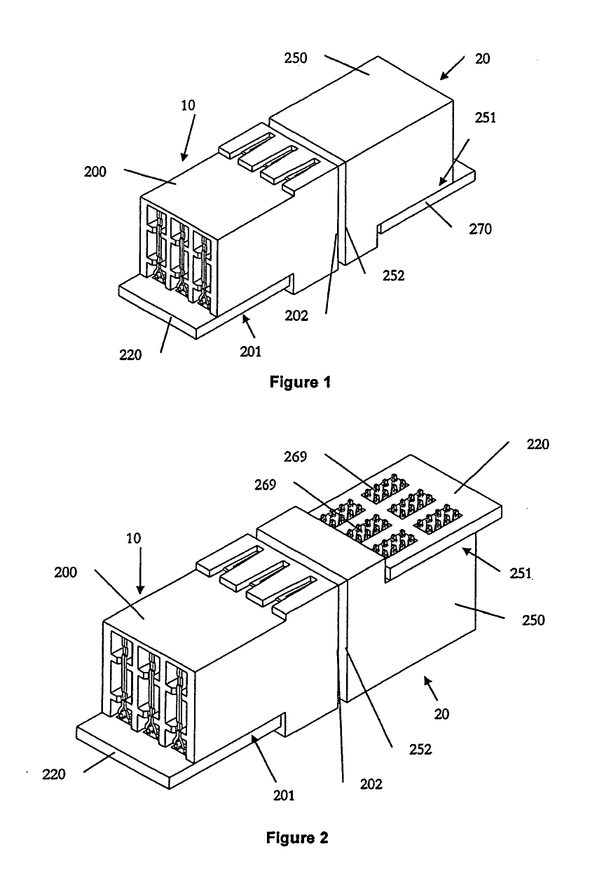

When the plug and the receptacle are connected/mated in a second mode as illustrated in FIGS. 2, 4 and 6 with the modules 220, 270 parallel but not in the same plane (so called inverse coplanar) the first connector circuit 111 is the same length as the second connector circuit 112. The second mode of mating provides for the current to be equal in both circuits and allows maximisation of the performance of the circuit and therefore improves the connector performance.

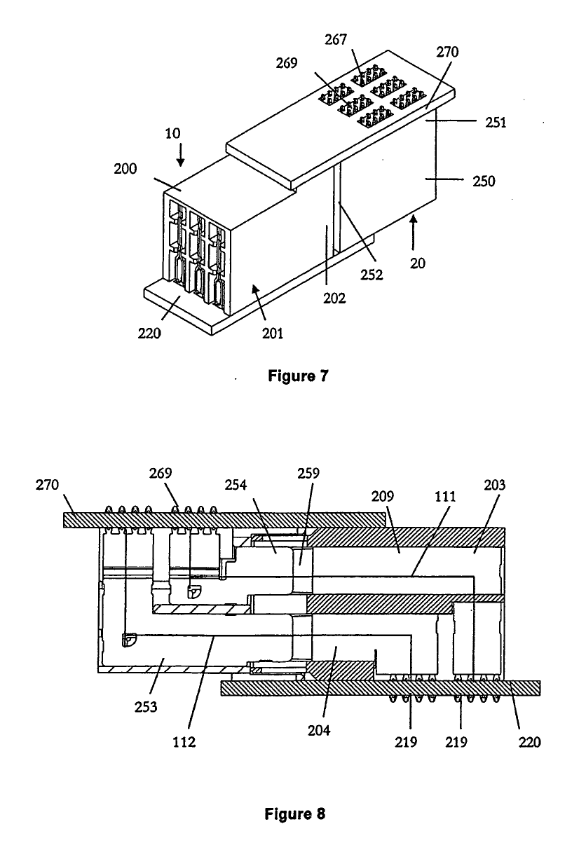

Referring to FIGS. 7 and 8 when the plug and receptacle are connected/mated in a second mode and the plug and receptacle each have an attached module, the parallel modules 220, 270 can overlap providing greater flexibility and better space management.

The terminals and the circuits of the present invention are integrated within the insulated housings of the plug and receptade using known methods such as having a two piece housing snap fittable together or being moulded within the housing. It is anticipated that multiple parallel first and second connector circuits would exist within the plug 10 and receptacle 20.

The foregoing describes the invention with reference to the disclosed embodiment Alterations and modifications as will be obvious to those skilled in the art are intended to be incorporated within the scope of the invention as defined in the accompanying claims.

1. A matable electrical connector, for connecting electrical modules, comprising:
a plug, said plug including a mating end, mating terminals at said mating end, a module mounting surface substantially perpendicular to said mating end, said module mounting surface including module terminals electrically connectable to said module, and at least one circuit connecting said module terminals to said mating terminals;
a receptacle, said receptacle including a mating end, mating terminals at said mating end, a module mounting surface substantially perpendicular to said mating end, said module mounting surface including module terminals electrically connectable to said module, and at least one circuit connecting said module terminals to said mating terminals;
wherein said plug and said receptacle are adapted to mate in a first mode wherein said module mounting surfaces of said plug and said receptacle are substantially coplanar and a second mode wherein the plane of said module mounting surfaces of said plug and said receptacle are substantially parallel but not coplanar.

2. A matable electrical connector, for connecting electrical modules, as claimed in claim 1, wherein said electrical module is a PCB.

3. A matable electrical connector, for connecting electrical modules, as claimed in claim 1, wherein said plug has at least one circuit of a first length (said first plug circuit) and at least one circuit of a second length (said second plug circuit), said first plug circuit being shorter than said second plug circuit and said receptacle has at least one circuit of a first length (said first receptacle circuit) and at least one circuit of a second length (said second receptacle circuit), said first receptacle circuit being shorter than said second receptacle circuit and wherein when and said receptacle are mated in said second mode said first plug circuit and said second receptacle circuit connect to form a first connector circuit and said second plug circuit and said first receptacle circuit connect to form a second connector circuit, said first and said second connector circuits being substantially the same length.

4. A matable electrical connector, for connecting electrical modules, as claimed in claim 2, wherein said electrical module is a PCB.

5. A matable electrical connector, for connecting electrical modules, as claimed in claim 1 including an electrical module to each of said plug and said receptacle, each electrical module being in the same plane as said module mounting surface wherein when said plug and said receptacle are mated in said second mode, said electrical modules are staggered.

6. A matable electrical connector, for connecting electrical modules, as claimed in claim 5, wherein said electrical module is a PCB.

7. A matable electrical connector, for connecting electrical modules, as claimed in claim 1 including an electrical module attached to each of said plug and said receptacle, each electrical module being in the same plane as said module mounting surface wherein when said plug and said receptacle are mated in said second mode, said electrical modules are substantially aligned.

8. A matable electrical connector, for connecting electrical modules, as claimed in claim 7, wherein said electrical module is a PCB.

9. A matable electrical connector, for connecting electrical modules, as claimed in claim 1 including an electrical module attached to each of said plug and said receptacle, each electrical module being in the same plane as said module mounting surface wherein when said plug and said receptacle are mated in said second mode, said electrical modules overlap.

10. A matable electrical connector, for connecting electrical modules, as claimed in claim 9, wherein said electrical module is a PCB.

11. A matable electrical connector, for connecting electrical modules, as claimed in claim 1, where the plug and the receptacle are each mounted on a PCB.
